(19) United States
(12) Patent Application Publication
(10) Pub. No.: US 2026/0169967 A1
(43) Pub. Date: Jun. 18, 2026

(54) SYSTEMS AND METHODS FOR ENABLING SIMILARITY SEARCH USING LOSS-PERMITTED CANDIDATES REPRESENTATION

(71) Applicant: Forter Ltd, New York, NY (US)

(72) Inventors: Matan Rosenberg, Petah Tikva (IL); Udi Luxenburg, Tel Aviv (IL); Tomer Assif, Tel Aviv (IL); Rotem Levin, Ramat-Gan (IL); Re'em Bensimhon, Tel Aviv (IL)

(73) Assignee: Forter Ltd, New York, NY (US)

(21) Appl. No.: 19/416,684

(22) Filed: Dec. 11, 2025

Related U.S. Application Data
(60) Provisional application No. 63/733,780, filed on Dec. 13, 2024.

(51) Int. Cl. G06F 16/22; G06F 16/2455; G06F 16/27

(52) U.S. Cl. CPC G06F 16/2228; G06F 16/2455; G06F 16/27

(57) ABSTRACT

Provided is a method for performing similarity search. The method comprises generating a reverse index from entity data, wherein the reverse index comprises entries where each entry has a key corresponding to a characteristic value of an entity and a value containing a list of entity identifiers in which the characteristic value appeared and a count of entities in which the characteristic value appeared. The method further comprises eliminating or reducing the list of entity identifiers for entries where the count exceeds a predetermined threshold (e.g., loss-permitted). Using loss-permitted reverse indexing, the system enables efficient storage/retrieval of high-dimensional data, allowing real-time similarity calculations for recommendation engines, image search, anomaly detection, and fraud detection. Similarity search results leverage compacted reverse indexes, and can be based on retrieving entries corresponding to characteristic values of a query entity, and calculating similarity scores using value importance (e.g., via count information weight) in matching operations.

### RELATED APPLICATIONS

This application claims the benefit under 35 U.S.C. § 119(e) of U.S. Provisional Application Ser. No. 63/733,780, filed Dec. 13, 2024, and entitled “SYSTEMS AND METHODS FOR ENABLING SIMILARITY SEARCH USING LOSS-PERMITTED CANDIDATES REPRESENTATION,” which is hereby incorporated herein by reference in its entirety.

### BACKGROUND

Generally stated, similarity search encompasses a host of challenges that include the problem of asserting whether there is a match between a particular entity and a large number of entities that are candidates to match said entity. This is usually done by mounting the evidence from comparing the values of the items in a vector of characteristics of the single entity to the values of these characteristics in each of the large number of candidate entities.

### SUMMARY

The inventors have realized that difficulties result from conventional approaches, including the difficulty in mounting the evidence from multiple characteristics of the entities and the large difference in information gain in the matching values. For example, a common value, which appears associated with a single entity and matches a particular entity from the pool of candidate entities, may not be a strong indication of a match if it also appears associated with or in many other entities of the candidate pool. On the other hand, if the same value appears only in a single candidate entity, or very few candidate entities, it can indicate a strong match. Taking into consideration the frequency of appearance in the candidates' corpus, for example, by methods such as TF-IDF, usually require access in real-time query to all the possible values in the pool, an expensive process in latency, computational load, and database management, which puts a practical limit on the scale of the candidate pool.

Further examples of issues resulting from the management of distributed databases, in which the needed information for a particular query can be distributed (e.g., among many shards as needed traditionally for considering term frequency). The execution of such queries can be inefficient and require non-linear efforts and resources as the number and complexity of the entities grow. For example, in known approaches (e.g., described in U.S. Pat. No. 9,721,253), a probabilistic method is applied to the matching problem. Such a solution requires a large amount of resources and engineering effort to scale. Such cost and latency limitations are a strong practical hindrance in applications such as image processing and recommendations in interactive sessions, searching for matching text documents in real time, and fraud detection, where the time allocation for matching an entity to one or more entities among billions of entities in the candidate pool can be a small fraction of a second.

According to some embodiments, a system and method for similarity search is provided. The system is specially configured to reduce the amount of stored and searched data, leveraging the omission of usage of matching characteristic values that are common (e.g., hence have limited contribution to the probability of a match). The systems and methods described can include the creation of reverse-indexed representations of high-dimensional data points, removal of listings of documents sharing values which are common values, enabling efficient similarity calculations, among other examples. In further embodiments, the efficiency created enables the use of embedded DBs, which can contain on many occasions the full corpus of candidate entities in a single computer storage, further reducing and simplifying computation and network load, reducing latency, and reducing management and maintenance costs. According to various embodiments, having an embedded DB enables easy offline generation of the reverse-index, which in turn allows doing data maintenance strictly offline. The results, in various examples, include a reduction in resource demand of the online environment, subsequently reducing query latency and improving cost-efficiency, thereby improving over known implementation and approaches.

According to an aspect of the present disclosure, a computer implemented method for performing similarity search is provided. The method comprises generating, by at least one processor, an inverse index, wherein the inverse index is generated so that a key in a key-document data store that is a value of a characteristic of a candidate entity and the value in the key-document data store contains at least (a) a list of IDs of entities in which this value appeared for the particular characteristic and (b) a count of documents in which the value appeared for the characteristic. The method further comprises determining a result of the similarity search based on the inverse index.

According to other aspects of the present disclosure, the method can include one or more of the following features. The count of documents can define the importance of each particular value of a particular characteristic of an entity in the match between entities. The characteristics for which the count is beyond a particular threshold may not be used or weighted in the matching process. The method can include an evaluation of criteria that can include at least one of: recency, predetermined characteristics, or predetermined characteristic values, or can include a combination of the foregoing and count thresholds. The method can include identifying the count exceeds a threshold for document IDs for values, and in response, excluding those document IDs or listing such IDs partially or with a weighting. The method can include evaluation of criteria such as, but not limited to: recency, predetermined characteristics, predetermined characteristic values, or a combination of these and count thresholds.

According to another aspect of the present disclosure, a system is provided. The system comprises at least one processor operatively connected to a memory, the at least one processor when executing is configured to leverage a single computer instance database, possibly an embedded database, possibly scaled out by duplication of said database, for real-time similarity search, optimizing query response times and computation and storage loads through the method of any of the foregoing aspects.

Still other aspects, examples, and advantages of these exemplary aspects and examples, are discussed in detail below. Moreover, it is to be understood that both the foregoing information and the following detailed description are merely illustrative examples of various aspects and examples and are intended to provide an overview or framework for understanding the nature and character of the claimed aspects and examples. Any example disclosed herein can be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example can be included in at least one example. The appearances of such terms herein are not necessarily all referring to the same example.

### BRIEF DESCRIPTION OF FIGURES

Various aspects of at least one embodiment are discussed herein with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by reference signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component can be labeled in every figure. In the figures:

FIG. 1 illustrates a block diagram of system components and process flow for generating compacted reverse-indexed files, according to one embodiment;

FIG. 2 illustrates a block diagram of system components and process flow for performing similarity search operations, according to one embodiment;

FIG. 3 illustrates a block diagram of system components and process flow for maintaining currency of a reverse-indexed database, according to one embodiment;

FIG. 4 illustrates a block diagram of system components and process flow for creating snapshots of the reverse-indexed database, according to one embodiment;

FIG. 5 illustrates a block diagram of a similarity search system with compacted reverse indexing components, according to one embodiment; and

FIG. 6 illustrates a block diagram of an entity processing architecture for performing similarity search operations, according to one embodiment; and

FIG. 7 is a block diagram of an example special-purpose computer system improved by the implementation of the functions and/or processes disclosed herein.

### DETAILED DESCRIPTION

The following description sets forth exemplary aspects. It should be recognized, however, that such description is not intended as a limitation on the scope of the present disclosure. Rather, the description also encompasses combinations and modifications to those exemplary aspects described herein.

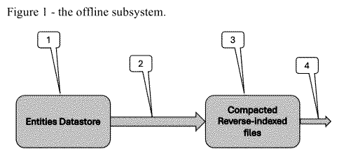

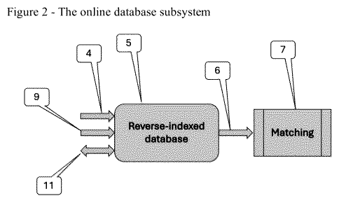

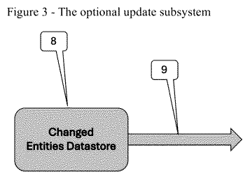

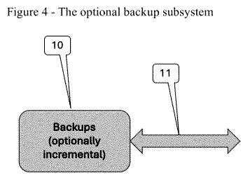

According to one embodiment, the system comprises: an offline sub-system (e.g., depicted in FIG. 1), which creates the reverse indexed data files, apply the compaction of them by culling the ID lists of documents for common values, and load them into a database; an online database (e.g., depicted in FIG. 2), possibly an embedded database in which all data of the candidates' entities corpus can be contained in a single computer storage- and includes means to query the above database; optionally, an update subsystem (e.g., depicted in FIG. 3), which can add, remove, or modify entries in the online database due to changes in the entities corpus since the last update or initialization of the database; and optionally a backup system (e.g., depicted in FIG. 4), which can accelerate the restoration of the online database in case of its failure on one or more of the computers from which it operates.

Various embodiments leverage loss-permitted reverse indexing, optionally over an embedded database. The loss-permitted reverse index enables efficient storage and retrieval of high-dimensional data of possibly high variance of information gain among dimensions, allowing real-time similarity calculations for applications such as recommendation engines, image search, anomaly detection and fraud detection. By utilizing optimized data structure, this method reduces computational load and latency, improving the practicality of real time similarity search and assertion.

Further embodiments provide for a system and method for similarity search by reducing the amount of stored and searched data, leveraging omission of usage of matching characteristic values, which are common, and hence have limited contribution to the probability of a match. The method includes creating reverse-indexed representations of high-dimensional data points, removal of listings of documents sharing values which are common, enabling efficient similarity calculations (e.g., loss-permitted indexing). Further, the efficiency created enables the use of embedded DBs, which can contain in many occasions the full corpus of candidate entities in single computer storage, further reducing and simplifying computation and network load, reducing latency and reducing management and maintenance costs. Having an embedded DB enables easy offline generation of the reverse-index, which in turn allows doing data maintenance strictly offline. This reduces resource demand of the online environment, subsequently reducing query latency and improving cost-efficiency.

Examples of the methods, devices, and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements, and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular can also embrace embodiments including a plurality, and any references in plural to any embodiment, component, element, or act herein can also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms.

According to one embodiment, an offline subsystem and flow is shown in FIG. 1. As shown, the flow can begin with an Entities datastore (item 1 in FIG. 1) comprised of entities, each of them including at least of an ID and a list of characteristics, each of these characteristics can also have a value. At item 2 in the flow, a scan is executed on the entities, and for each of the encountered values of each of the characteristics of the entity, a reverse-indexed entry is created. The reverse index entry key is the unique value for the characteristic, and the reverse index value consists of (a) the list of IDs of entities in which the unique value appeared for the particular characteristic and (b) the count of documents in which the value appeared for the characteristic.

According to one embodiment, given the count for each entry for an entity-characteristic-value, the system reduces or eliminates the list of IDs of entities for the entry. The logic can include erasing all IDs if the count is larger than a particular value, or a more sophisticated logic depending on the particular use-case. For example, such further logic can be dictated by the desired level of approximation of the full Bayesian inference formulation, by engineering cost or complexity considerations, by the utility of the outcome (for example in the fraud detection embodiment, where matching fraudster to their past activities is more important than matching a legitimate person to their past activities and hence the count threshold for erasure of particular characteristic values can better be lower), or by a combination of these considerations.

The results are files containing the compacted reverse-indexed data (for example, shown as item 3 in FIG. 1) which then can be loaded (e.g., item 4 in FIG. 1) to the database. The process can run periodically, a-periodically, and/or according to a schedule or trigger.

FIG. 2 shows an example online subsystem and flow. The flow can begin with a compacted reverse-indexed database (e.g., item 5 in FIG. 2), which can be instantiated (optionally) an embedded database in which the full corpus of entities reside on single computer storage, and can be fed by the loader described above (e.g., item 4), optionally by an updater described below (e.g., item 9), and in still other embodiments (optionally) backup and restore the database for fast recovery, which can be executed incrementally (e.g., item 11), among other options.

According to one embodiment, the matching process (e.g., item 7) queries the database (e.g., item 6) by retrieving the entry for each entity characteristic value (e.g., which is the key of the reverse index) and uses the count to assign importance to the entry in the matching process. Higher counts will generally lead to lower importance, and possibly for counts above a particular threshold, which can be the same threshold used for eliminating entries to the entity IDs list, where the entry will not be used at all. This process does not restrict the matching process and does not dictate its internals, which can use cosine similarity, Euclidean distances, or a full Bayesian chain, among other methods.

This setup allows flexibility in supporting different queries across distinct data sets, each with its own tailored set of fields.

FIG. 3 illustrates an optional update subsystem and flow. According to one embodiment, flow can begin with any change in the entities datastore that occurred after the last update of the reverse-index database (e.g., item 8). Upon such a change, the flow (for example, executed by the system) triggers an update (e.g., item 9) to the reverse-index database. The trigger can be, among other options, a post-update event of the entities datastore, or polling of the last update timestamp of the entities data store and the reverse-index database. The update may or may not be immediate, and can include buffering of changes.

FIG. 4 illustrates an optional backup subsystem and flow. The flow can begin with the database being backed up and restored (e.g., item 11), possibly incrementally, into snapshots of particular timestamps (e.g., item 10), in order to prevent the need for a more lengthy (computationally burdensome) re-reverse-indexing of the database.

Aspects of the disclosure describe advances over known approaches and improvements in processing. Various embodiments leverage reverse-indexing to improve over known approaches and can include, for example, compacted reverse indexing, and leveraging the reverse correlation between the count of appearances of particular characteristic values (as an approximation to how common the value is in the entity's population) and matching information gain. In other embodiments, the systems and methods leverage the compaction to enable a complete reverse index database implemented/executed on a single computer and its storage, which can be instantiated as an embedded database, which in turn enables a relatively easy scaling out through the repeated deployment of data-identical computer instances, among other options.

### Example Use Cases

According to various embodiments, the systems and methods described herein are applicable in a wide variety of use cases including, but not limited to, image retrieval, where for example vectorization of the images into attributes' vectors enable the match of an image to images in a large deposit of images based on images content rather than graphical descriptors; Natural Language Processing, where attributes' values of documents can be reverse-indexed and compacted to match documents based on content (for example, by sentiment or general subject); identity matching and fraud detection, where the persona or transaction attributes can be matched efficiently, based on relative rarity of their attributes values.

### Example Embodiments

As an example of a specific use case and a specific implementation, the system and method are applicable to identity matching, possibly in the context of fraud prevention. In that context, the match of an event such as a payment transaction to previous actions by the same person is not always simple. A legitimate person can use a different computer, give different contact details, or connect to the internet differently; a fraudster can try to use the identity of another person, or outright present a new persona where few attributes match their previous appearances. In such cases, the system cannot rely on unique identifiers, such as cookies, and need to mount the evidence we have, taking into account the rarity of each attribute.

For example, the importance of the IP address in the match is proportional to its rarity: an IP address that appeared only once, can well be of a residential access point and is a strong identifier; conversely, an IP that appeared 50 times, is most probably a mobile or public IP address, and is a weaker identifier. Similarly, an email address is a strong identifier. But an email domain strength depends on its rarity as can be seen in the following example:

Consider the following small excerpt from a large identity datastore (could be stored in item 1 in FIG. 1):

[1: {‘e_domain’: gmail.com, IP: 123.123.123.123}, 2: {‘e_domain’: smb.com, IP:
123.123.123.123} ]

In this example, gmail.com appears as the email domain in 300,000 entities, and smb.com appeared in 4 entities, the IP 123.456.543.321 appeared twice.

The indexation process (e.g., item 2 in FIG. 1) creates the following reverse index entries:

```
[
  e_domain_gmail.com: {IDs: null, count: 300,000},
  E_domain_smb.com: {IDs: [2, 345, 42582, 78392], count: 4},
  IP_123.123.123.123: {IDs: [1, 2], count: 2},
]
```

According to some examples, as the count of entities for which gmail.com is the email domain, their IDs, in this particular example, are not listed. This enables the matching process, when querying the compacted reverse-indexed database, to ignore the email domain if the entity to match has gmail.com as its email domain, and thus to both reduce substantially the storage needs and accelerate the query and retrieval of entities data.

To further this example, as most attributes' values of most of the entities are quite common, the compaction of the entries of the reverse index database enables the complete database to reside on a single computer instance. This in turn enables the usage of an embedded database engine, and scaling out for redundancy, throughput and concurrency by simply duplicating the database among computer instances, reducing network traffic, increasing reliability, and reducing cost. These implementation options improve over known approaches. Periodic data maintenance tasks can be completely ignored by the update process since the offline reverse-index generation process will automatically incorporate them when processing the Entities Datastore

According to further embodiments, referring to FIG. 1, an offline subsystem can generate compacted reverse-indexed files for similarity search operations. The offline subsystem can include an entities datastore 1, a reverse-indexing process 2, compacted reverse-indexed files 3, and a loader 4. The entities datastore 1 can store entities, where each entity can include an identifier and a list of characteristics with associated values.

According to some embodiments, the entities datastore 1 can be distributed among multiple shards to facilitate processing of terms frequency across large datasets. The distributed architecture can enable the system to handle substantial volumes of entity data while maintaining processing efficiency. The reverse-indexing process 2 can scan entities from the entities datastore 1 to create reverse-indexed entries for similarity matching operations.

According to various embodiments, with continued reference to FIG. 1, the reverse-indexing process 2 can generate reverse-indexed entries where keys correspond to characteristic values and values contain lists of entity identifiers along with occurrence counts. For each encountered value of each characteristic, the reverse-indexing process 2 can create an entry where the reverse index entry key represents the unique value for the characteristic. The reverse index value can consist of a list of identifiers of entities in which the unique value appeared for the particular characteristic and a count of documents in which the value appeared for the characteristic.

According to another embodiment, the reverse-indexing process 2 can apply compaction by reducing or eliminating lists of entity identifiers based on count thresholds. The compaction logic can erase all identifiers when the count exceeds a particular threshold value. The reverse-indexing process 2 can implement sophisticated logic depending on the particular use case, such as fraud detection applications, where matching fraudulent actors to their past activities can receive different treatment than matching legitimate persons to their activities.

According to one embodiment, as further shown in FIG. 1, the reverse-indexing process 2 can execute periodically, aperiodically, or according to a schedule or trigger mechanism. The scheduling flexibility can allow the system to adapt to varying data update frequencies and processing requirements. The reverse-indexing process 2 can generate the compacted reverse-indexed files 3 containing processed data with reduced storage requirements compared to uncompacted reverse indexes.

According to some embodiments, the loader 4 can receive the compacted reverse-indexed files 3 and load the processed index data into a database for subsequent querying and matching operations. The loader 4 can transfer the compacted reverse-indexed data to enable real-time similarity search capabilities while maintaining reduced computational overhead through the compaction approach implemented by the reverse-indexing process 2.

According to one embodiment, referring to FIG. 2, an online database subsystem can perform similarity search operations using compacted reverse-indexed data. The online database subsystem can include a reverse-indexed database 5 that stores the processed index information generated by the loader 4. The reverse-indexed database 5 can receive the compacted reverse-indexed files from the loader 4 to populate the database with indexed entries for similarity matching operations.

According to some embodiments, with continued reference to FIG. 2, the reverse-indexed database 5 can be instantiated as an embedded database in which a full corpus of entities can reside on single computer storage. The embedded database implementation can enable the system to contain all candidate entities within a single computer instance, reducing network traffic and improving query response times. The reverse-indexed database 5 can be scaled out for redundancy, throughput and concurrency by duplicating the database among computer instances.

According to various embodiments, as further shown in FIG. 2, a query interface 6 can provide access to the reverse-indexed database 5 for retrieving indexed entries based on characteristic values. The query interface 6 can enable retrieval of reverse-indexed entries where each entry corresponds to a characteristic value key and contains count information along with entity identifier lists when available. The query interface 6 can facilitate communication between external query requests and the stored reverse-indexed data.

According to another embodiment, a matching process 7 can connect to the reverse-indexed database 5 via the query interface 6 to perform similarity calculations between entities. The matching process 7 can retrieve entries from the reverse-indexed database 5 and utilize count information to determine the importance of characteristic values in similarity matching operations. The matching process 7 can assign lower importance to characteristic values with higher counts, as higher counts can indicate more common values that provide less discriminative power for entity matching.

According to one embodiment, with continued reference to FIG. 2, the matching process 7 can use cosine similarity, Euclidean distances or full Bayesian chain methods for similarity calculations. The matching process 7 can ignore characteristic values when counts exceed particular thresholds, where the thresholds can correspond to the same values used during the compaction process performed by the reverse-indexing process 2. The matching process 7 can support different queries across distinct data sets, where each data set can have a tailored set of fields for specific similarity search applications.

According to some embodiments, as further shown in FIG. 2, an updater 9 can connect to the reverse-indexed database 5 to modify, add, or remove entries in response to changes in the underlying entity corpus. The updater 9 can maintain the currency of the reverse-indexed database 5 by incorporating modifications that occur after initial database creation or previous update cycles. The updater 9 can process entity changes to ensure the reverse-indexed database 5 reflects current entity information for accurate similarity search results.

According to various embodiments, a backup process 11 can connect to the reverse-indexed database 5 to create snapshots of the database for recovery purposes. The backup process 11 can operate incrementally to generate snapshots at particular timestamps, enabling restoration of the reverse-indexed database 5 without requiring complete re-indexing operations. The backup process 11 can provide data integrity protection and enable rapid restoration of the online database subsystem in case of system failures.

According to one embodiment, referring to FIG. 3, an update subsystem can maintain database currency by processing changes to entity data that occur after initial database creation or previous update cycles. The update subsystem can include a changed entities datastore 8 and the updater 9. The changed entities datastore 8 can store information about entities that have been modified, added, or removed since the last update of the reverse-indexed database 5.

According to some embodiments, with continued reference to FIG. 3, the changed entities datastore 8 can connect to the updater 9 to provide change information for processing database updates. The changed entities datastore 8 can track modifications to entity characteristics, additions of new entities, and removals of existing entities from the entities datastore 1. The data flow from the changed entities datastore 8 to the updater 9 can enable the system to identify and process specific changes without requiring complete reprocessing of the entire entity corpus.

According to various embodiments, as further shown in FIG. 3, the updater 9 can receive changed entity information from the changed entities datastore 8 and process these changes to update the reverse-indexed database 5 accordingly. The updater 9 can incorporate entity modifications by adjusting reverse-indexed entries, updating occurrence counts, and modifying entity identifier lists as needed. The updater 9 can add new reverse-indexed entries for newly introduced characteristic values and remove entries for deleted entities.

According to another embodiment, the updater 9 can be triggered by event-driven mechanisms such as post-update events from the entities datastore 1 or polling mechanisms that compare timestamps between the entities datastore 1 and the reverse-indexed database 5. The post-update event trigger can provide immediate notification when changes occur in the entities datastore 1, enabling the updater 9 to process modifications promptly. The polling mechanism can periodically check timestamp differences to identify when updates are needed for the reverse-indexed database 5.

According to one embodiment, with continued reference to FIG. 3, the updater 9 can implement buffered update processing where changes are collected and processed in batches rather than individually. The buffering approach can improve processing efficiency by reducing the frequency of database update operations while maintaining data currency within acceptable time windows. The updater 9 can process buffered changes according to configurable schedules or when buffer capacity thresholds are reached.

According to some embodiments, the updater 9 can operate with varying immediacy levels depending on system requirements and processing constraints. The updater 9 can provide immediate updates for time-sensitive applications or delayed updates for systems where processing efficiency takes precedence over real-time data currency. The flexible update timing can allow the system to balance between data freshness and computational resource utilization based on specific application needs.

According to one embodiment, referring to FIG. 4, a backup subsystem can provide database recovery capabilities for the similarity search system. The backup subsystem can include the backup process 11 and backup snapshots 10. The backup process 11 can create and restore database snapshots to facilitate recovery operations without requiring complete re-indexing of the reverse-indexed database 5.

According to some embodiments, with continued reference to FIG. 4, the backup snapshots 10 can store database state information at particular timestamps to enable point-in-time recovery of the reverse-indexed database 5. The backup snapshots 10 can connect to the backup process 11 through a bidirectional data flow that enables both snapshot creation and restoration operations. The bidirectional connection can allow the backup process 11 to write snapshot data to the backup snapshots 10 during backup operations and read snapshot data from the backup snapshots 10 during restoration operations.

According to various embodiments, as further shown in FIG. 4, the backup process 11 can execute incrementally to generate the backup snapshots 10 at particular timestamps. The incremental backup approach can capture changes that occur between backup intervals rather than creating complete database copies for each snapshot. The backup process 11 can reduce storage requirements and processing time by storing only the modifications that have occurred since the previous backup snapshot.

According to another embodiment, the backup process 11 can create timestamped backup snapshots 10 that correspond to specific points in time when the reverse-indexed database 5 contained particular data states. The timestamped approach can enable the system to restore the reverse-indexed database 5 to any available snapshot timestamp, providing flexibility in recovery operations. The backup process 11 can maintain multiple backup snapshots 10 with different timestamps to support recovery to various historical database states.

According to one embodiment, with continued reference to FIG. 4, the backup process 11 can restore the reverse-indexed database 5 from the backup snapshots 10 without requiring complete re-reverse-indexing of entity data from the entities datastore 1. The restoration capability can reduce recovery time compared to regenerating the reverse-indexed database 5 through the reverse-indexing process 2. The backup process 11 can select appropriate backup snapshots 10 based on desired restoration timestamps and apply incremental changes as needed to achieve the target database state.

According to some embodiments, the backup process 11 can coordinate with the updater 9 to ensure consistency between backup operations and database update operations. The coordination can prevent conflicts between backup creation and database modifications that could result in inconsistent backup snapshots 10. The backup process 11 can schedule backup operations during periods of reduced update activity or implement locking mechanisms to maintain data integrity during snapshot creation.

According to one embodiment, the similarity search system can be applied to image retrieval applications where vectorization of images into attribute vectors enables matching based on content rather than graphical descriptors. The system can process image data by converting visual content into characteristic vectors that represent features such as color distributions, texture patterns, shape descriptors, and spatial relationships within the images. The reverse-indexing process can create indexed entries for each attribute value derived from the image vectorization, where common attribute values that appear across many images receive reduced storage allocation through the compaction approach.

According to some embodiments, the image retrieval application can utilize the compacted reverse indexing to identify similar images within large image repositories based on content similarity rather than metadata or filename matching. The matching process can retrieve reverse-indexed entries corresponding to image attribute values and calculate similarity scores based on the frequency and rarity of shared attributes between a query image and candidate images in the repository. Rare attribute values that appear in few images can receive higher importance weights during similarity calculations, while common attribute values that appear across many images can receive lower importance weights or can be excluded from matching operations when their occurrence counts exceed predetermined thresholds.

According to various embodiments, the similarity search system can be applied to Natural Language Processing applications where attribute values of documents can be reverse-indexed and compacted to match documents based on content characteristics such as sentiment or general subject matter. The system can process textual documents by extracting linguistic features, semantic attributes, and content descriptors that represent document characteristics including word frequencies, phrase patterns, sentiment indicators, topic classifications, and syntactic structures. The reverse-indexing process can generate indexed entries for each extracted attribute value, where the compaction engine can reduce storage requirements by eliminating entity identifier lists for attribute values that appear frequently across the document corpus.

According to another embodiment, the Natural Language Processing application can enable document matching based on content similarity rather than exact text matching or keyword searches. The matching process can compare documents by evaluating shared attribute values related to sentiment analysis results, topic classifications, or thematic content indicators. Documents sharing rare sentiment patterns or uncommon topic combinations can receive higher similarity scores, while documents sharing common linguistic attributes can receive lower similarity scores based on the frequency-based weighting approach implemented through the compacted reverse indexing structure.

According to one embodiment, the similarity search system can be applied to identity matching and fraud detection applications where persona or transaction attributes can be matched efficiently based on relative rarity of attribute values. The system can process identity data and transaction records by extracting characteristic attributes such as email domains, IP addresses, device identifiers, behavioral patterns, transaction amounts, geographic locations, and temporal patterns. The reverse-indexing process can create indexed entries for each attribute value associated with personas or transactions, where the compaction approach can eliminate identifier lists for attribute values that appear frequently across the dataset while preserving detailed information for rare attribute values.

According to some embodiments, the fraud detection application can leverage the rarity-based matching approach to identify potentially fraudulent activities by detecting unusual combinations of attribute values or connections between entities with rare shared characteristics. The matching process can assign higher importance to rare attribute values such as uncommon IP addresses, unique device fingerprints, or unusual transaction patterns that appear in few entities within the dataset. Common attribute values such as popular email domains or frequently used IP addresses can receive lower importance weights or can be excluded from matching calculations when their occurrence counts exceed specified thresholds.

According to various embodiments, the identity matching application can distinguish between legitimate users who can use different devices, provide varying contact details, or connect from different network locations, and fraudulent actors who can attempt to use stolen identities or create false personas. The system can mount evidence from multiple attribute comparisons while accounting for the discriminative power of each attribute based on its rarity within the candidate pool. The compacted reverse indexing approach can enable real-time fraud detection by reducing computational overhead and storage requirements while maintaining the ability to identify meaningful connections between entities based on shared rare characteristics.

According to one embodiment, an index system can provide comprehensive similarity search capabilities through multiple interconnected components that work together to process entity data and perform matching operations. The index system can include a reverse-indexed component that handles data processing and storage operations, a similarity search component that performs matching calculations, a database currency component that maintains data accuracy over time, and a database recovery component that provides backup and restoration capabilities.

According to some embodiments, the reverse-indexed component can perform offline processing operations to generate compacted reverse-indexed data structures from entity information. The reverse-indexed component can include an index generator that creates reverse-indexed entries from entity characteristic values, where each entry maps characteristic values to lists of entity identifiers and occurrence counts. The reverse-indexed component can further include a compaction engine that processes the reverse-indexed entries to reduce storage requirements by eliminating or reducing entity identifier lists based on frequency thresholds.

According to various embodiments, the compaction engine within the reverse-indexed component can implement logic that erases entity identifier lists when occurrence counts exceed predetermined threshold values. The compaction engine can apply different threshold criteria depending on the specific use case, such as fraud detection applications where different treatment can be applied to fraudulent versus legitimate entity matching scenarios. The reverse-indexed component can generate compacted data files that contain processed index information with reduced storage requirements compared to uncompacted reverse indexes.

According to another embodiment, the reverse-indexed component can include a query interface that provides access to the compacted reverse-indexed data for similarity search operations. The query interface can enable retrieval of indexed entries based on characteristic value keys, where each retrieved entry can contain count information and entity identifier lists when available after compaction processing. The query interface can facilitate communication between external query requests and the stored reverse-indexed data within the index system.

According to one embodiment, the similarity search component can perform online matching operations using the compacted reverse-indexed data generated by the reverse-indexed component. The similarity search component can include a matching engine that retrieves indexed entries through the query interface and performs similarity calculations between entities based on shared characteristic values. The matching engine can utilize count information from the reverse-indexed entries to determine the importance of characteristic values in similarity matching operations.

According to some embodiments, the similarity search component can include a scoring module that calculates similarity scores based on the frequency and rarity of shared attributes between entities. The scoring module can assign lower importance weights to characteristic values with higher occurrence counts, as higher counts can indicate more common values that provide less discriminative power for entity matching. The scoring module can ignore characteristic values when their occurrence counts exceed particular thresholds that correspond to the compaction thresholds used by the reverse-indexed component.

According to various embodiments, the matching engine within the similarity search component can implement different similarity calculation methods including cosine similarity, Euclidean distance calculations, or full Bayesian inference approaches. The matching engine can support different query types across distinct datasets, where each dataset can have tailored field configurations for specific similarity search applications. The similarity search component can provide flexible matching capabilities that can be adapted to various use cases and data types.

According to another embodiment, the database currency component can maintain the accuracy and timeliness of the reverse-indexed data by processing changes that occur in the underlying entity data after initial database creation or previous update cycles. The database currency component can include a change detector that monitors modifications to entity data and identifies additions, deletions, or modifications to entity characteristics and values. The change detector can track changes through event-driven mechanisms or polling approaches that compare timestamps between data sources.

According to one embodiment, the database currency component can include an update processor that receives change information from the change detector and processes these modifications to update the reverse-indexed data accordingly. The update processor can incorporate entity modifications by adjusting reverse-indexed entries, updating occurrence counts, and modifying entity identifier lists as needed. The update processor can add new reverse-indexed entries for newly introduced characteristic values and remove entries for deleted entities while maintaining the compaction logic applied during initial index generation.

According to some embodiments, the update processor within the database currency component can implement buffered update processing where changes are collected and processed in batches rather than individually. The buffering approach can improve processing efficiency by reducing the frequency of database update operations while maintaining data currency within acceptable time windows. The update processor can process buffered changes according to configurable schedules or when buffer capacity thresholds are reached.

According to various embodiments, the database recovery component can provide backup and restoration capabilities for the index system to ensure data integrity and enable rapid recovery from system failures. The database recovery component can include a backup manager that creates snapshots of the reverse-indexed data at particular timestamps to enable point-in-time recovery operations. The backup manager can execute incrementally to capture changes that occur between backup intervals rather than creating complete data copies for each snapshot.

According to another embodiment, the database recovery component can include a restore engine that reconstructs the reverse-indexed data from backup snapshots without requiring complete re-indexing of entity data from original sources. The restore engine can select appropriate backup snapshots based on desired restoration timestamps and apply incremental changes as needed to achieve target data states. The database recovery component can coordinate with the database currency component to ensure consistency between backup operations and ongoing update operations.

According to one embodiment, the index system can be configured to support image retrieval applications where the reverse-indexed component processes vectorized image data to create indexed entries for visual content attributes. The similarity search component can match images based on content characteristics such as color distributions, texture patterns, and spatial relationships rather than metadata or filename matching. The database currency component can maintain updated image attribute indexes as new images are added to repositories, while the database recovery component can provide backup capabilities for large image datasets.

According to some embodiments, the index system can be adapted for Natural Language Processing applications where the reverse-indexed component processes textual documents to extract linguistic features, semantic attributes, and content descriptors. The similarity search component can match documents based on sentiment analysis results, topic classifications, or thematic content indicators rather than exact text matching. The compacted indexing approach can reduce storage requirements for common linguistic attributes while preserving detailed information for rare semantic patterns.

According to various embodiments, the index system can be configured for identity matching and fraud detection applications where the reverse-indexed component processes persona and transaction attributes to create indexed entries based on characteristic rarity. The similarity search component can identify potentially fraudulent activities by detecting unusual combinations of attribute values or connections between entities with rare shared characteristics. The database currency component can maintain updated identity and transaction indexes in real-time to support immediate fraud detection capabilities.

According to another embodiment, the index system can leverage embedded database implementations where the complete reverse-indexed data can reside within single computer storage instances. The embedded database approach can enable the index system to reduce network traffic, improve query response times, and simplify scaling operations through database duplication across multiple computer instances. The embedded implementation can facilitate offline data maintenance operations while reducing computational overhead in online query environments.

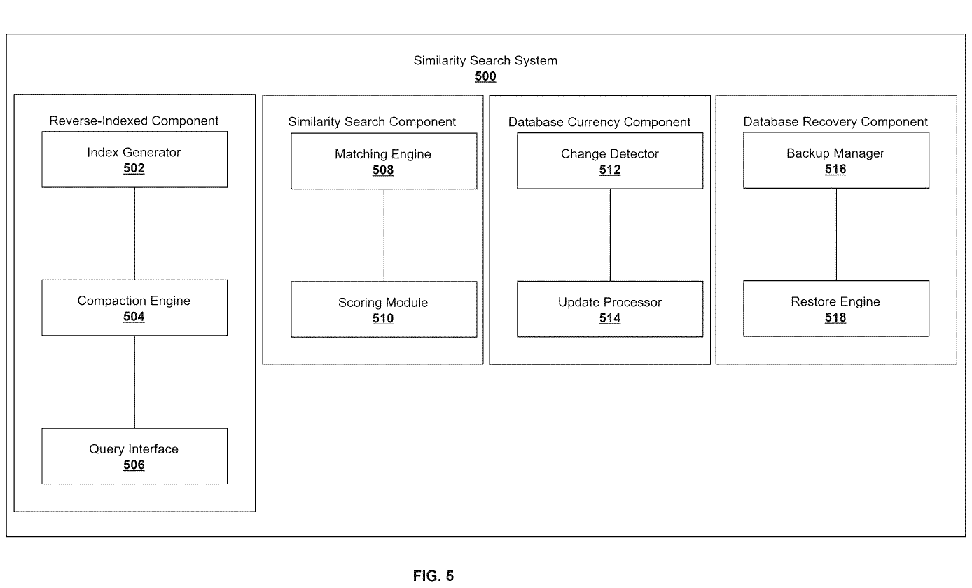

According to one embodiment, referring to FIG. 5, a similarity search system 100 can provide comprehensive entity matching capabilities through multiple interconnected components that work together to process entity data and perform efficient similarity search operations. The similarity search system 100 can include a reverse-indexed component 102, a similarity search component 110, a database currency component 116, and a database recovery component 122. The similarity search system 100 can leverage compacted reverse indexing to reduce computational load and storage requirements while maintaining search accuracy for real-time similarity matching applications.

According to some embodiments, with continued reference to FIG. 5, the reverse-indexed component 102 can form the core data processing portion of the similarity search system 100. The reverse-indexed component 102 can handle offline processing operations to generate compacted reverse-indexed data structures from entity information stored in the entities datastore (e.g., 1 FIG. 1). The reverse-indexed component 102 can include an index generator 104, a compaction engine 106, and a query interface 108 that work together to create, process, and provide access to reverse-indexed data for similarity search operations.

According to various embodiments, as further shown in FIG. 5, the index generator 104 within the reverse-indexed component 102 can create reverse-indexed entries from entity characteristic values received from the entities datastore (e.g., 1 FIG. 1). The index generator 104 can scan entity data and generate entries where keys correspond to unique characteristic values and values contain lists of entity identifiers along with occurrence counts. The index generator 104 can process each encountered value of each characteristic to create reverse index entries that map characteristic values to the entities containing those values.

According to another embodiment, the index generator 104 can connect to the compaction engine 106 within the reverse-indexed component 102 to enable processing of the generated reverse-indexed entries. The compaction engine 106 can receive reverse-indexed entries from the index generator 104 and process these entries to reduce storage requirements by eliminating or reducing lists of entity identifiers based on frequency thresholds. The compaction engine 106 can implement logic that erases entity identifier lists when occurrence counts exceed predetermined threshold values to optimize storage utilization.

According to one embodiment, with continued reference to FIG. 5, the compaction engine 106 can apply different compaction criteria depending on specific use cases and application requirements. The compaction engine 106 can implement sophisticated logic for fraud detection applications where different treatment can be applied to fraudulent versus legitimate entity matching scenarios. The compaction engine 106 can generate compacted reverse-indexed data that maintains discriminative information for rare characteristic values while reducing storage overhead for common values.

According to some embodiments, as further shown in FIG. 5, the compaction engine 106 can connect to the query interface 108 within the reverse-indexed component 102 to provide access to the processed reverse-indexed data. The query interface 108 can receive compacted reverse-indexed data from the compaction engine 106 and enable retrieval of indexed entries based on characteristic value keys. The query interface 108 can facilitate communication between external query requests and the stored reverse-indexed data within the similarity search system 100.

According to various embodiments, the query interface 108 can provide access to indexed entries that contain count information and entity identifier lists when available after compaction processing by the compaction engine 106. The query interface 108 can enable the similarity search component 110 to retrieve reverse-indexed entries for similarity matching operations. The query interface 108 can support different query types across distinct datasets where each dataset can have tailored field configurations for specific similarity search applications.

According to another embodiment, with continued reference to FIG. 5, the similarity search component 110 can handle matching and scoring operations within the similarity search system 100. The similarity search component 110 can perform online matching operations using the compacted reverse-indexed data generated by the reverse-indexed component 102. The similarity search component 110 can include a matching engine 112 and a scoring module 114 that work together to calculate similarity scores and determine match importance based on characteristic value frequencies.

According to one embodiment, as further shown in FIG. 5, the matching engine 112 within the similarity search component 110 can connect to the query interface 108 to retrieve indexed entries and perform entity matching operations. The matching engine 112 can access reverse-indexed entries through the query interface 108 and perform similarity calculations between entities based on shared characteristic values. The matching engine 112 can utilize count information from the reverse-indexed entries to determine the discriminative power of characteristic values in similarity matching operations.

According to some embodiments, the matching engine 112 can connect to the scoring module 114 within the similarity search component 110 to enable similarity score calculations. The scoring module 114 can receive matching results from the matching engine 112 and calculate similarity scores based on the frequency and rarity of shared attributes between entities. The scoring module 114 can assign lower importance weights to characteristic values with higher occurrence counts while providing higher weights to rare characteristic values that appear in fewer entities.

According to various embodiments, with continued reference to FIG. 5, the scoring module 114 can implement different similarity calculation methods including cosine similarity, Euclidean distance calculations, or full Bayesian inference approaches. The scoring module 114 can ignore characteristic values when their occurrence counts exceed particular thresholds that correspond to the compaction thresholds used by the compaction engine 106. The scoring module 114 can provide flexible scoring capabilities that can be adapted to various use cases and data types within the similarity search system 100.

According to another embodiment, as further shown in FIG. 5, the database currency component 116 can maintain the accuracy and timeliness of the reverse-indexed data within the similarity search system 100. The database currency component 116 can process changes that occur in the underlying entity data after initial database creation or previous update cycles. The database currency component 116 can include a change detector 118 and an update processor 120 that work together to identify and process modifications to entity data.

According to one embodiment, the change detector 118 within the database currency component 116 can monitor modifications to entity data and identify additions, deletions, or modifications to entity characteristics and values. The change detector 118 can track changes through event-driven mechanisms that respond to modifications in the entities datastore (e.g., 1 FIG. 1) or through polling approaches that compare timestamps between data sources. The change detector 118 can connect to the update processor 120 to provide change information for processing database updates.

According to some embodiments, with continued reference to FIG. 5, the update processor 120 within the database currency component 116 can receive change information from the change detector 118 and process these modifications to update the reverse-indexed data accordingly. The update processor 120 can incorporate entity modifications by adjusting reverse-indexed entries, updating occurrence counts, and modifying entity identifier lists as needed. The update processor 120 can connect to the reverse-indexed component 102 via a dashed connection that indicates periodic or conditional updates to maintain database currency.

According to various embodiments, as further shown in FIG. 5, the update processor 120 can implement buffered update processing where changes are collected and processed in batches rather than individually. The update processor 120 can improve processing efficiency by reducing the frequency of database update operations while maintaining data currency within acceptable time windows. The update processor 120 can process buffered changes according to configurable schedules or when buffer capacity thresholds are reached to balance between data freshness and computational resource utilization.

According to another embodiment, the database recovery component 122 can provide backup and restoration capabilities for the similarity search system 100 to ensure data integrity and enable rapid recovery from system failures. The database recovery component 122 can include a backup manager 124 and a restore engine 126 that work together to create snapshots and reconstruct reverse-indexed data when needed. The database recovery component 122 can connect to the reverse-indexed component 102 via a dashed connection that enables restoration of indexed data during recovery operations.

According to one embodiment, with continued reference to FIG. 5, the backup manager 124 within the database recovery component 122 can create snapshots of the reverse-indexed data at particular timestamps to enable point-in-time recovery operations. The backup manager 124 can execute incrementally to capture changes that occur between backup intervals rather than creating complete data copies for each snapshot. The backup manager 124 can connect to the restore engine 126 to enable coordination between backup creation and restoration operations within the database recovery component 122.

According to some embodiments, as further shown in FIG. 5, the restore engine 126 within the database recovery component 122 can reconstruct reverse-indexed data from backup snapshots without requiring complete re-indexing of entity data from the entities datastore (e.g., 1 FIG. 1). The restore engine 126 can receive backup information from the backup manager 124 and select appropriate backup snapshots based on desired restoration timestamps. The restore engine 126 can apply incremental changes as needed to achieve target data states during recovery operations.

According to various embodiments, the restore engine 126 can coordinate with the database currency component 116 to ensure consistency between restoration operations and ongoing update operations managed by the update processor 120. The restore engine 126 can implement recovery procedures that maintain the compaction logic applied during initial index generation by the compaction engine 106. The restore engine 126 can enable rapid restoration of the similarity search system 100 without compromising the storage optimization benefits provided by the compacted reverse indexing approach.

According to another embodiment, with continued reference to FIG. 5, the interconnected components within the similarity search system 100 can work together to provide efficient real-time similarity search operations. The reverse-indexed component 102 can generate and maintain compacted reverse-indexed data that the similarity search component 110 can access through the query interface 108 to perform matching operations. The database currency component 116 can ensure data accuracy over time while the database recovery component 122 can provide backup protection for the entire similarity search system 100.

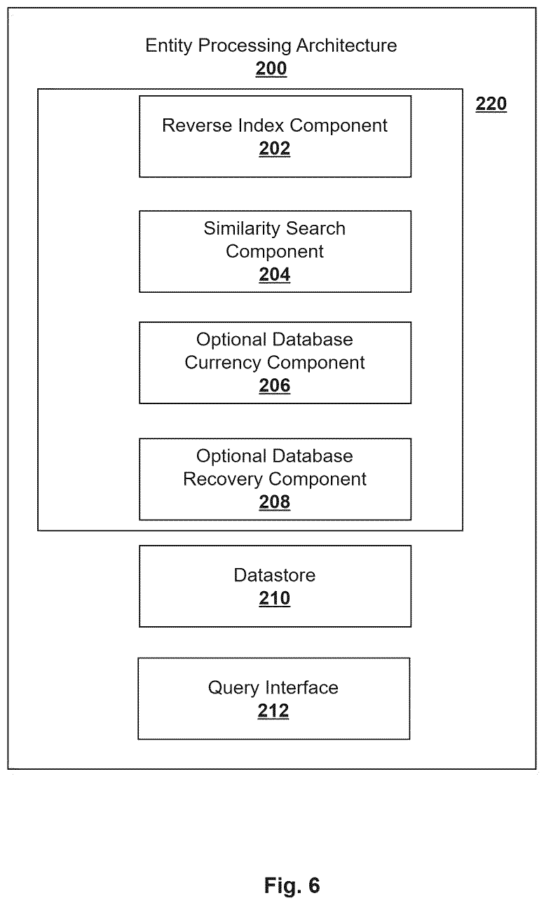

According to one embodiment, referring to FIG. 6, an entity processing architecture 200 can provide comprehensive similarity search capabilities through multiple interconnected components that process entity data and deliver matching results. The entity processing architecture 200 can include a reverse-indexed component 202, a similarity search component 204, a database currency component 206, and a database recovery component 208. The entity processing architecture 200 can operate by receiving entity data from external sources, processing the data through indexed structures, and delivering similarity search results through a structured data flow pathway.

According to some embodiments, with continued reference to FIG. 6, an entity datastore 210 can serve as the source of entity data for the entity processing architecture 200. The entity datastore 210 can be positioned external to the entity processing architecture 200 and can contain entities with associated characteristics and values that form the basis for similarity search operations. The entity datastore 210 can connect to the reverse-indexed component 202 through a solid connection that indicates the primary flow of entity data for indexing operations within the entity processing architecture 200.

According to various embodiments, as further shown in FIG. 6, the reverse-indexed component 202 can be implemented as a cylindrical storage element that processes and stores indexed data received from the entity datastore 210. The reverse-indexed component 202 can receive entity data through the solid connection from the entity datastore 210 and can generate reverse-indexed entries for entity characteristics and values. The reverse-indexed component 202 can apply compaction processing to reduce storage requirements while maintaining discriminative information for similarity matching operations within the entity processing architecture 200.

According to another embodiment, the reverse-indexed component 202 can connect to a query interface 212 through a solid connection that enables access to the processed indexed data. The query interface 212 can receive processed data from the reverse-indexed component 202 and can provide a communication pathway for external query requests to access the stored reverse-indexed information. The query interface 212 can facilitate retrieval of indexed entries based on characteristic value keys and can forward query requests to subsequent processing components within the entity processing architecture 200.

According to one embodiment, with continued reference to FIG. 6, the query interface 212 can connect to the similarity search component 204 through a solid connection that enables the transfer of query information for matching operations. The similarity search component 204 can be represented as a cloud-based processing element that performs matching operations on the indexed data received through the query interface 212. The similarity search component 204 can calculate similarity scores between entities based on shared characteristic values and can determine match importance using frequency-based weighting approaches.

According to some embodiments, as further shown in FIG. 6, the similarity search component 204 can process similarity calculations using various methods including cosine similarity, Euclidean distance calculations, or Bayesian inference approaches. The similarity search component 204 can utilize count information from reverse-indexed entries to assign importance weights to characteristic values during matching operations. The similarity search component 204 can ignore or reduce the influence of characteristic values that exceed predetermined frequency thresholds while emphasizing rare characteristic values that provide greater discriminative power for entity matching.

According to various embodiments, the similarity search component 204 can connect to a results output 214 through a solid connection that delivers similarity search results from the entity processing architecture 200. The results output 214 can receive processed similarity calculations from the similarity search component 204 and can provide the final matching results to external systems or applications. The results output 214 can complete the primary data flow path through the entity processing architecture 200 by delivering similarity search outcomes based on the indexed data processing and matching operations.

According to another embodiment, with continued reference to FIG. 6, the database currency component 206 can maintain the timeliness and accuracy of the stored data within the entity processing architecture 200. The database currency component 206 can connect to the reverse-indexed component 202 through a dashed connection that indicates a supporting role in maintaining indexed data currency. The dashed connection can represent periodic or conditional updates that the database currency component 206 can perform to incorporate changes in the entity datastore 210 without disrupting the primary data flow pathway through the entity processing architecture 200.

According to one embodiment, as further shown in FIG. 6, the database currency component 206 can monitor modifications to entity data and can process additions, deletions, or changes to entity characteristics and values. The database currency component 206 can track changes through event-driven mechanisms or polling approaches that identify when updates are needed for the reverse-indexed component 202. The database currency component 206 can implement buffered update processing to collect and process changes in batches while maintaining data accuracy within acceptable time windows.

According to some embodiments, the database recovery component 208 can provide backup and restoration capabilities for the entity processing architecture 200. The database recovery component 208 can be shown as a server element that connects to the reverse-indexed component 202 through a dashed connection indicating its supporting role in protecting indexed data. The database recovery component 208 can create snapshots of the reverse-indexed data at particular timestamps and can enable restoration operations without requiring complete re-indexing of entity data from the entity datastore 210.

According to various embodiments, with continued reference to FIG. 6, the database recovery component 208 can execute incremental backup operations that capture changes occurring between backup intervals rather than creating complete data copies for each snapshot. The database recovery component 208 can coordinate with the database currency component 206 to ensure consistency between backup operations and ongoing update operations. The database recovery component 208 can enable rapid restoration of the reverse-indexed component 202 while maintaining the compaction benefits achieved through the indexed data processing approach.

According to another embodiment, as further shown in FIG. 6, the entity processing architecture 200 can operate through a coordinated data flow that begins with entity data from the entity datastore 210 and concludes with similarity search results from the results output 214. The primary data flow can follow solid connections from the entity datastore 210 through the reverse-indexed component 202, the query interface 212, and the similarity search component 204 to the results output 214. The supporting components including the database currency component 206 and the database recovery component 208 can connect through dashed connections to provide ongoing maintenance and protection services without interfering with the primary processing pathway.

According to one embodiment, the entity processing architecture 200 can support various similarity search applications including image retrieval, natural language processing, identity matching, and fraud detection. The reverse-indexed component 202 can process different types of entity data including image attributes, textual features, identity characteristics, or transaction patterns depending on the specific application requirements. The similarity search component 204 can adapt matching algorithms and scoring approaches based on the type of entity data and the desired similarity criteria for each application domain.

According to some embodiments, with continued reference to FIG. 6, the entity processing architecture 200 can leverage embedded database implementations where the reverse-indexed component 202 can contain complete indexed data within single computer storage instances. The embedded approach can enable the entity processing architecture 200 to reduce network traffic and improve query response times by maintaining all indexed data locally. The entity processing architecture 200 can scale through duplication of the indexed data across multiple computer instances while maintaining consistency through the database currency component 206 and protection through the database recovery component 208.

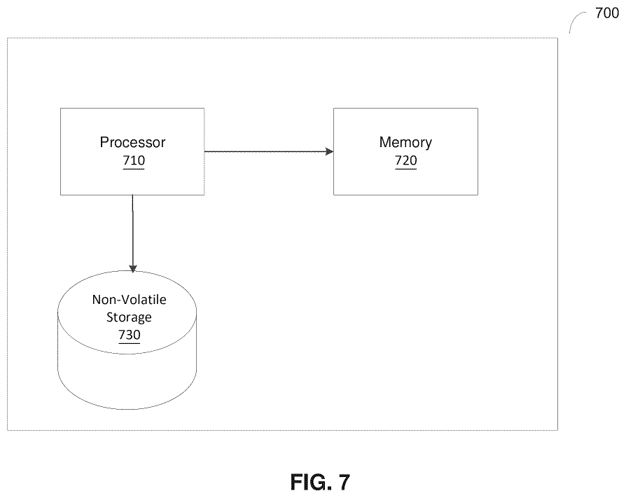

Additionally, an illustrative implementation of a special purpose computer system 700, that can be specially programmed to improve over conventional systems, to be used in connection with any of the embodiments of the disclosure provided herein is shown in FIG. 7. The computer system 700 can include one or more processors 710 and one or more articles of manufacture that comprise non-transitory computer-readable storage media (e.g., memory 720 and one or more non-volatile storage media 770). The processor 710 can control writing data to and reading data from the memory 720 and the non-volatile storage device 770 in any suitable manner. To perform any of the functionality described herein (e.g., secure execution, search, index construction, etc.), the processor 710 can execute one or more processor-executable instructions stored in one or more non-transitory computer-readable storage media (e.g., the memory 720), which can serve as non-transitory computer-readable storage media storing processor-executable instructions for execution by the processor 710.

### Numbered Embodiments

1. A computer implemented method for performing similarity search is provided, comprising: generating, by at least one processor, a reverse index from entity data, wherein the reverse index comprises entries where each entry has a key corresponding to a characteristic value of an entity and a value containing at least a list of entity identifiers in which the characteristic value appeared and a count of entities in which the characteristic value appeared; applying compaction to the reverse index by eliminating or reducing the list of entity identifiers for entries where the count exceeds a predetermined threshold; and determining a result of the similarity search based on the compacted reverse index by retrieving entries corresponding to characteristic values of a query entity and calculating similarity scores using the count information to weight the importance of characteristic values in matching operations.

2. The method of any preceding embodiment, wherein the count information defines the importance of each characteristic value in matching operations between entities. 3. The method of claim 2, wherein characteristic values having counts beyond the predetermined threshold are not used in the matching operations. 4. The method of any preceding embodiment, wherein applying compaction includes evaluating criteria comprising at least one of recency, predetermined characteristics, predetermined characteristic values, or a combination thereof with count thresholds. 5. The method of any preceding embodiment, wherein calculating similarity scores comprises using at least one of cosine similarity, Euclidean distance calculations, or Bayesian inference methods. 6. The method of any preceding embodiment, further comprising storing the compacted reverse index in an embedded database contained within a single computer storage. 7. The method of any preceding embodiment, further comprising scaling the embedded database by duplicating the database across multiple computer instances for redundancy and throughput.

8. A similarity search system is provided, comprising: at least one processor; and a memory operatively connected to the at least one processor, wherein the at least one processor is configured to: generate a reverse index from entity data stored in an entity datastore, wherein the reverse index maps characteristic values to lists of entity identifiers and occurrence counts; apply a compaction process to reduce storage requirements by removing entity identifier lists for characteristic values having occurrence counts above a threshold; store the compacted reverse index in a database; receive similarity search queries for target entities; retrieve reverse index entries corresponding to characteristic values of the target entities; and calculate similarity scores between the target entities and candidate entities using the occurrence counts to determine the discriminative power of shared characteristic values. 9. The system of any preceding embodiment, wherein the at least one processor is further configured to store the compacted reverse index in an embedded database contained within a single computer storage. 10. The system of any preceding embodiment, wherein the at least one processor is further configured to scale the embedded database by duplicating the database across multiple computer instances for redundancy and throughput. 11. The system of any preceding embodiment, wherein the at least one processor is configured to calculate similarity scores using at least one of cosine similarity, Euclidean distance calculations, or Bayesian inference methods. 12. The system of any preceding embodiment, wherein the at least one processor is further configured to apply the compaction process by evaluating criteria comprising at least one of recency, predetermined characteristics, predetermined characteristic values, or a combination thereof with count thresholds. 13. The system of any preceding embodiment, wherein the at least one processor is further configured to: monitor changes to the entity data in the entity datastore; and update the compacted reverse index by processing additions, deletions, or modifications to entity characteristics and values. 14. The system of any preceding embodiment, wherein the at least one processor is configured to update the compacted reverse index using buffered update processing that collects and processes changes in batches according to configurable schedules or buffer capacity thresholds. 15. A non-transitory computer-readable storage medium storing processor-executable instructions that, when executed by at least one processor, cause the at least one processor to perform operations is provide, comprising: creating a reverse index structure from a corpus of entities, each entity having an identifier and characteristic values, wherein the reverse index structure comprises entries mapping each unique characteristic value to a list of entity identifiers containing that characteristic value and a count of entities containing that characteristic value; compacting the reverse index structure by eliminating entity identifier lists for characteristic values where the count exceeds a frequency threshold, thereby reducing storage requirements while preserving count information; and executing similarity search operations by accessing the compacted reverse index structure to retrieve count information for characteristic values of a query entity and using the count information to weight the significance of matching characteristic values during similarity calculations. 16. The medium of any preceding embodiment, wherein the operations further comprise storing the compacted reverse index structure in an embedded database contained within a single computer storage. 17. The medium of any preceding embodiment, wherein the operations further comprise scaling the embedded database by duplicating the database across multiple computer instances for redundancy and throughput. 18. The medium of any preceding embodiment, wherein executing similarity search operations comprises calculating similarity scores using at least one of cosine similarity, Euclidean distance calculations, or Bayesian inference methods. 19. The medium of any preceding embodiment, wherein compacting the reverse index structure comprises evaluating criteria comprising at least one of recency, predetermined characteristics, predetermined characteristic values, or a combination thereof with count thresholds. 20. The medium of any preceding embodiment, wherein the operations further comprise monitoring changes to the corpus of entities and updating the compacted reverse index structure by processing additions, deletions, or modifications to entity characteristics and values using buffered update processing that collects and processes changes in batches.

The terms “program” or “software” or “app” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but can be distributed in a modular fashion among different computers or processors to implement various aspects of the disclosure provided herein.

Processor-executable instructions can be in many forms, such as program modules, executed by one or more computers or other devices. Generally, program modules include routines, programs, objects, components, data structures, etc. that perform particular tasks or implement particular abstract data types. Typically, the functionality of the program modules can be combined or distributed as desired in various embodiments.

Also, data structures can be stored in one or more non-transitory computer-readable storage media in any suitable form. For simplicity of illustration, data structures can be shown to have fields that are related through location in the data structure. Such relationships can likewise be achieved by assigning storage for the fields with locations in a non-transitory computer-readable medium that convey relationships between the fields. However, any suitable mechanism can be used to establish relationships among information in fields of a data structure, including through the use of pointers, tags or other mechanisms that establish relationships among data elements.

Also, various inventive concepts can be embodied as one or more processes, of which examples have been provided. The acts performed as part of each process can be ordered in any suitable way. Accordingly, embodiments can be constructed in which acts are performed in an order different than illustrated, which can include performing some acts simultaneously, even though shown as sequential acts in illustrative embodiments.

All definitions, as defined and used herein, should be understood to control over dictionary definitions, and/or ordinary meanings of the defined terms. As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements.

This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having the same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed:

1. A computer implemented method for performing similarity search, comprising:
generating, by at least one processor, a reverse index from entity data, wherein the reverse index comprises entries where each entry has a key corresponding to a characteristic value of an entity and a value containing at least a list of entity identifiers in which the characteristic value appeared and a count of entities in which the characteristic value appeared;
applying compaction to the reverse index by eliminating or reducing the list of entity identifiers for entries where the count exceeds a predetermined threshold; and
determining a result of the similarity search based on the compacted reverse index by retrieving entries corresponding to characteristic values of a query entity and calculating similarity scores using the count information to weight the importance of characteristic values in matching operations.

2. The method of claim 1, wherein the count information defines the importance of each characteristic value in matching operations between entities.

3. The method of claim 2, wherein characteristic values having counts beyond the predetermined threshold are not used in the matching operations.

4. The method of claim 1, wherein applying compaction includes evaluating criteria comprising at least one of recency, predetermined characteristics, predetermined characteristic values, or a combination thereof with count thresholds.

5. The method of claim 1, wherein calculating similarity scores comprises using at least one of cosine similarity, Euclidean distance calculations, or Bayesian inference methods.

6. The method of claim 1, further comprising storing the compacted reverse index in an embedded database contained within a single computer storage.

7. The method of claim 6, further comprising scaling the embedded database by duplicating the database across multiple computer instances for redundancy and throughput.

8. A similarity search system, comprising:
at least one processor; and
a memory operatively connected to the at least one processor, wherein the at least one processor is configured to:
generate a reverse index from entity data stored in an entity datastore, wherein the reverse index maps characteristic values to lists of entity identifiers and occurrence counts;
apply a compaction process to reduce storage requirements by removing entity identifier lists for characteristic values having occurrence counts above a threshold;
store the compacted reverse index in a database;
receive similarity search queries for target entities;
retrieve reverse index entries corresponding to characteristic values of the target entities; and
calculate similarity scores between the target entities and candidate entities using the occurrence counts to determine the discriminative power of shared characteristic values.

9. The similarity search system of claim 8, wherein the at least one processor is further configured to store the compacted reverse index in an embedded database contained within a single computer storage.

10. The similarity search system of claim 9, wherein the at least one processor is further configured to scale the embedded database by duplicating the database across multiple computer instances for redundancy and throughput.

11. The similarity search system of claim 8, wherein the at least one processor is configured to calculate similarity scores using at least one of cosine similarity, Euclidean distance calculations, or Bayesian inference methods.

12. The similarity search system of claim 8, wherein the at least one processor is further configured to apply the compaction process by evaluating criteria comprising at least one of recency, predetermined characteristics, predetermined characteristic values, or a combination thereof with count thresholds.

13. The similarity search system of claim 8, wherein the at least one processor is further configured to:
monitor changes to the entity data in the entity datastore; and
update the compacted reverse index by processing additions, deletions, or modifications to entity characteristics and values.

14. The similarity search system of claim 13, wherein the at least one processor is configured to update the compacted reverse index using buffered update processing that collects and processes changes in batches according to configurable schedules or buffer capacity thresholds.

15. A non-transitory computer-readable storage medium storing processor-executable instructions that, when executed by at least one processor, cause the at least one processor to perform operations comprising:
creating a reverse index structure from a corpus of entities, each entity having an identifier and characteristic values, wherein the reverse index structure comprises entries mapping each unique characteristic value to a list of entity identifiers containing that characteristic value and a count of entities containing that characteristic value;
compacting the reverse index structure by eliminating entity identifier lists for characteristic values where the count exceeds a frequency threshold, thereby reducing storage requirements while preserving count information; and
executing similarity search operations by accessing the compacted reverse index structure to retrieve count information for characteristic values of a query entity and using the count information to weight the significance of matching characteristic values during similarity calculations.

16. The non-transitory computer-readable storage medium of claim 15, wherein the operations further comprise storing the compacted reverse index structure in an embedded database contained within a single computer storage.

17. The non-transitory computer-readable storage medium of claim 16, wherein the operations further comprise scaling the embedded database by duplicating the database across multiple computer instances for redundancy and throughput.

18. The non-transitory computer-readable storage medium of claim 15, wherein executing similarity search operations comprises calculating similarity scores using at least one of cosine similarity, Euclidean distance calculations, or Bayesian inference methods.

19. The non-transitory computer-readable storage medium of claim 15, wherein compacting the reverse index structure comprises evaluating criteria comprising at least one of recency, predetermined characteristics, predetermined characteristic values, or a combination thereof with count thresholds.

20. The non-transitory computer-readable storage medium of claim 17, wherein the operations further comprise monitoring changes to the corpus of entities and updating the compacted reverse index structure by processing additions, deletions, or modifications to entity characteristics and values using buffered update processing that collects and processes changes in batches.
